(19) United States
(12) Patent Application Publication
(10) Pub. No.: US 2009/0260785 A1
(43) Pub. Date: Oct. 22, 2009

(54) HEAT PLATE WITH CAPILLARY SUPPORTING STRUCTURE AND MANUFACTURING METHOD THEREOF

(76) Inventors: Cheng-Tu Wang, Taipei (TW); Pang-Hung Liao, Taipei (TW)

Correspondence Address: HDLS Patent & Trademark Services, P.O. BOX 220746, CHANTILLY, VA, 20153-0746, US

(21) Appl. No.: 12/104,622

(22) Filed: Apr. 17, 2008

(51) Int. Cl. F28F 3/14; B23P 15/26

(52) U.S. Cl. 165/170; 29/890.04

(57) ABSTRACT

In a heat plate having a hollow plate and capillary supporting structures, the plate body includes a capillary tissue attached on an internal wall of the plate body, and each of the capillary supporting structures is erected, supported and distributed in the plate body. Each capillary supporting structure is in a cylindrical shape and has a capillary object made of sintered powder and disposed on the circumferential surface of the cylindrical capillary supporting structure and contacted with the capillary tissue to form a continuous capillary channel and provide a capillary action to the capillary supporting structures in the heat plate.

### BACKGROUND OF THE INVENTION

1. Field of the Invention

The present invention generally relates to a thermal conduction technology, and more particularly to a capillary supporting structure of a heat plate and a method of manufacturing the capillary supporting structure.

2. Description of Prior Art

Heat plate is a heat pipe in form of a plate, and its operating principle is the same as that of the heat pipe, wherein a working fluid is filled into the hollow interior of the heat plate for dissipating heat. Since the phase of the working fluid can be changed by the heat, the working fluid is capable of resuming its liquid state when cooled and continuing a circulation after its backflow.

However, the manufacture of heat plates is not exactly the same as that of the heat pipes. In general, the heat pipe comes with a pipe body in a tubular shape with a closed end and an open end, and the open end is provided for filling in a working fluid, and removing and vacuuming the air in the heat pipe. The pipe body is sealed immediately after the process of removing air to complete the manufacture of the heat pipe. The heat plate having a body in a sheet shape is formed by upper and lower cover plates, and thus it does not only need to seal the periphery of the two cover plates, but also needs to enhance the support strength of the two cover plates for the air removal or vacuum operation. Therefore, the heat plate further contains a supporting structure for preventing the two cover plates from being indented by the foregoing operations.

The traditional heat plate has capillary structures attached onto an internal wall of the cover plate, but no capillary structure is provided or supported on a surface of the supporting structure between two cover plates. If the working fluid in the traditional heat plate changes its phase, the working fluid at a liquid state flows from the top of the internal wall of the heat plate to the internal wall of the periphery of the heat plate, before flowing back to the bottom of the internal wall of the heat plate. Therefore the backflow path becomes longer and affects the heat conduction of the heat plate.

In view of the shortcomings of the prior art, the inventor of the present invention based on years of experience in the related industry to conduct extensive researches and experiments, and finally developed a heat plate with a capillary supporting structure and its manufacturing method in accordance with the present invention.

### SUMMARY OF THE INVENTION

It is a primary objective of the present invention to overcome the foregoing shortcomings by providing a heat plate with a capillary supporting structure and its manufacturing method, wherein a sintered capillary tissue is attached onto the circumferential surface of the supporting structure in the heat plate for filling a working fluid into the heat plate directly, and providing a backflow path from the capillary tissue on the surface of the supporting structure.

Another objective of the present invention is to provide a heat plate with a capillary supporting structure and its manufacturing method, wherein the capillary tissue on the surface of the supporting structure is extended continuously to the top and bottom of the internal wall of the heat plate to facilitate the working fluid to flow back successfully.

To achieve the foregoing objective, the present invention provides a heat plate with a capillary supporting structure, comprising a hollow plate and a plurality of capillary supporting structures, wherein a capillary tissue is attached onto the internal wall of the plate body, and each capillary supporting structure is erected, supported and distributed in the plate body, and each capillary supporting structure substantially in a cylindrical shape has a capillary object made of a sintered powder, disposed around the circumferential surface of the cylindrical shape, and contacted with the capillary tissue at the internal wall of the plate body, so as to form a continuous capillary channel for achieving the foregoing objectives.

To achieve the foregoing objectives, the present invention provides a method of manufacturing a heat plate with a capillary supporting structure, and the method comprises the steps of:

(a) providing a sintering tool and a supporting object, wherein the sintering tool includes an indented portion therein for receiving the supporting object;

(b) placing the supporting object into the indented portion of the sintering tool;

(c) filling a sintered powder into the sintering tool and between the supporting objects;

(d) heating the sintered powder as described in Step (c) to a temperature for sintering the sintered powder onto a surface of the supporting object;

(e) releasing the mold of the supporting object with the sintered powder, and the sintering tool to obtain a capillary supporting structure;

(f) providing two cover plates engaged with each other as a plate body of a heat plate; and

(g) placing the capillary supporting structure as described in Step (e) into the plate body and sealing the plate body.

### BRIEF DESCRIPTION OF DRAWINGS

FIG. 1 is a flow chart of a manufacturing method of the present invention;

FIG. 2 is a schematic view of Steps S1 and S2 of a manufacturing method of the present invention;

FIG. 3 is a schematic view of Step S3 as illustrated in FIG. 1;

FIG. 4 is a schematic view of Step S5 as illustrated FIG. 1;

FIG. 5 is a schematic view of removing and cutting a supporting object as illustrated FIG. 4;

FIG. 6 is a schematic view of Step S5 as illustrated FIG. 1;

FIG. 7 is a schematic view of Steps S6 and S7 as illustrated FIG. 1;

FIG. 8 is a schematic view of detailed movements of Steps S6 and S7 as illustrated in FIG. 1, and a capillary supporting structure disposed on a cover plate in accordance with a first preferred embodiment of the present invention;

FIG. 9 is a schematic view of detailed movements of S6 and S7 as illustrated in FIG. 1, and a capillary tissue sintered on a cover plate in accordance with a first preferred embodiment of the present invention;

FIG. 10 is a schematic view of detailed movements of S6 and S7 as illustrated in FIG. 1, and two cover plates being sealed in accordance with a first preferred embodiment of the present invention;

FIG. 11 is a sectional view of a heat plate in accordance with a first preferred embodiment of the present invention;

FIG. 12 is an enlarged view of a portion A of FIG. 11;

FIG. 13 is a schematic view of detailed movements of Steps S6 and S7 as illustrated in FIG. 1, and a capillary supporting structure disposed on a cover plate in accordance with a second preferred embodiment of the present invention;

FIG. 14 is a schematic view of detailed movements of S6 and S7 as illustrated in FIG. 1, and two cover plates being sealed in accordance with a second preferred embodiment of the present invention; and

FIG. 15 is a schematic view of a heat plate in accordance with a second preferred embodiment of the present invention.

### DETAILED DESCRIPTION OF THE INVENTION

The technical characteristics, features and advantages of the present invention will become apparent in the following detailed description of preferred embodiments with reference to the accompanying drawings, and the preferred embodiments are used for illustrating the present invention only, but not intended to limit the scope of the present invention.

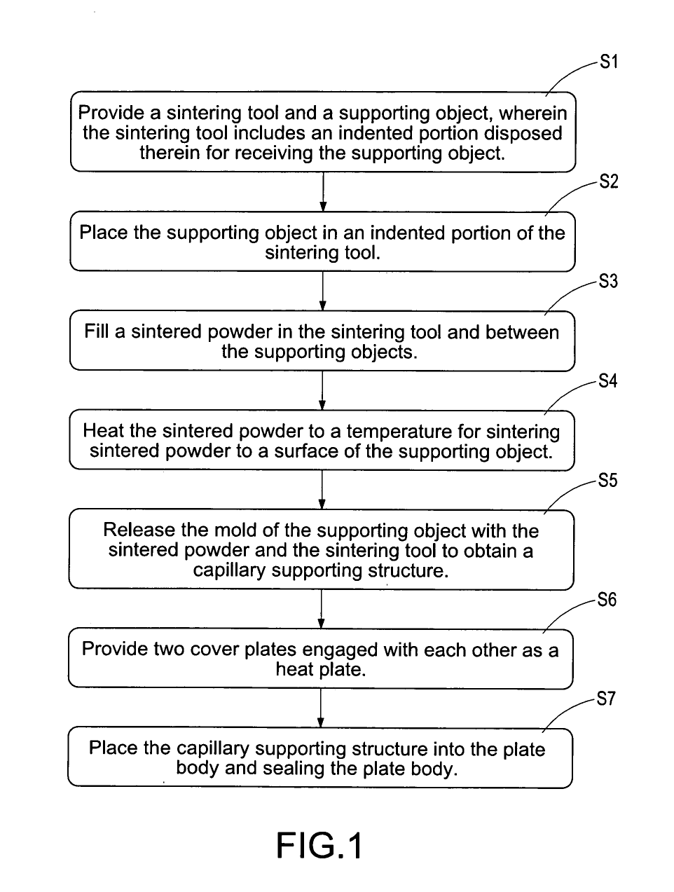

Referring to FIG. 1 for the flow chart of a method of the present invention, the invention provides a heat plate with a capillary supporting structure and a manufacturing method thereof. The method comprises the following steps:

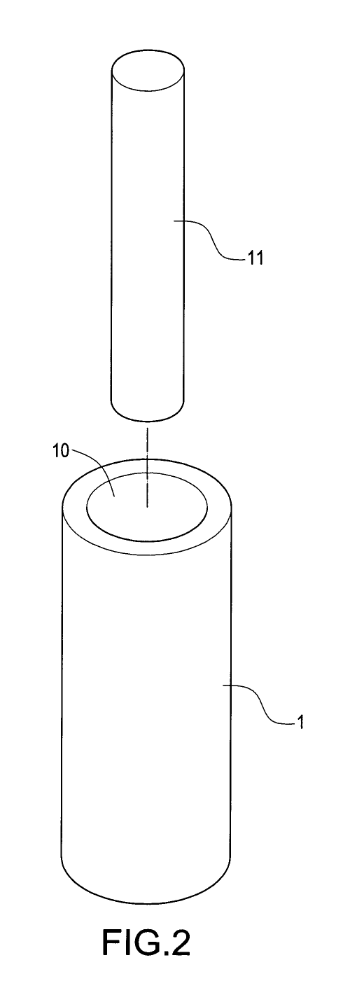

Referring to FIG. 2 together with Step S1 as shown in FIG. 1, a sintering tool 1 and a supporting object 11 are provided. The supporting object 11, substantially in the shape of a rectangular bar, is used as the material for making the supporting structure in the heat plate. After the following steps are completed, the supporting object 11 is manufactured and cut into the required supporting structure. The sintering tool 1 contains an indented portion 10 for erecting the supporting object 11 and receiving the supporting object 11 into an indented portion 10 of the sintering tool 1 as described in Step S2 (as shown in FIG. 1).

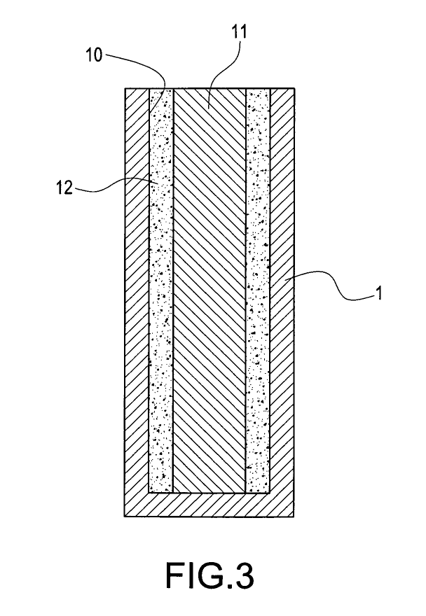

Referring to FIG. 3 together with Step S3 as shown in FIG. 1, a predetermined gap is formed between the internal walls of the supporting object 11 and the sintering tool 1, if the supporting object 11 is placed into the sintering tool. After the sintered powder 12 is filled into the gap between the sintering tool 1 and the supporting object 11, the sintered powder 12 in the sintering tool 1 provides a sintering temperature for sintering the sintered powder 12 onto the circumferential surface of the supporting object 11 to form the capillary object as described in Step S4 (as shown in FIG. 1).

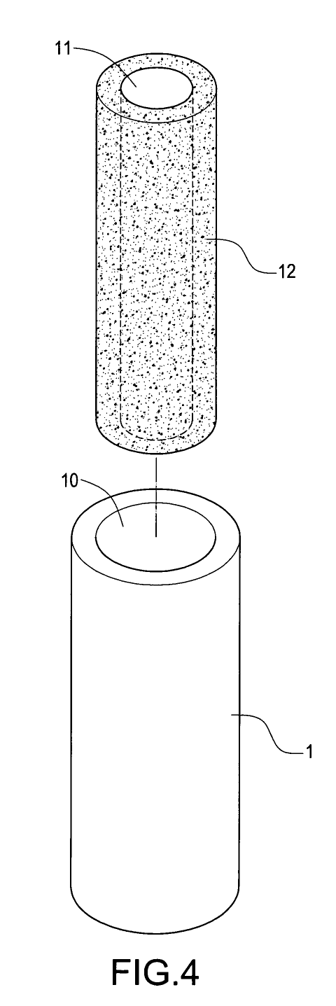

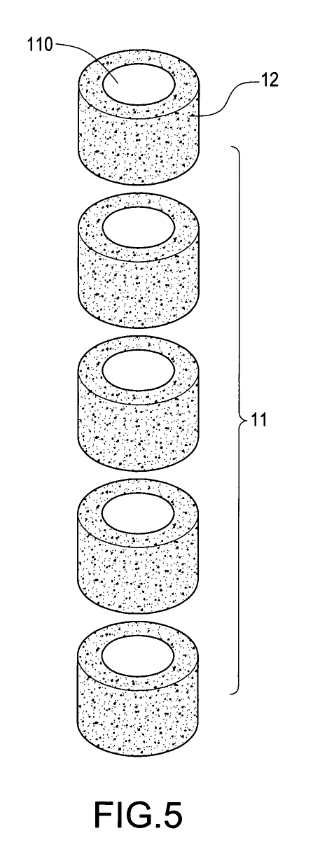

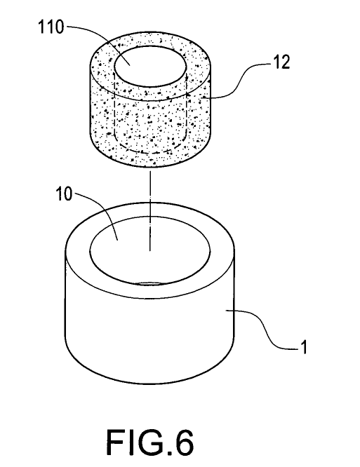

Referring to FIG. 4 together with Step S5 as shown in FIG. 1, the supporting object 11 with the sintered powder 12 and the sintering tool 1 are demolded after cooling. The supporting object 11 is cut into a plurality of capillary supporting structures 110 with an appropriate length, such as in a short cylindrical form (as shown in FIG. 5) for applying the capillary supporting structures 110 in the heat plate to form the heat plate with a capillary supporting structure. In Steps S1 to S5 as shown in FIG. 6, a capillary supporting structure 110 with an appropriate length matching with the sintering tool 1 is prepared directly without requiring the cutting process, and the capillary supporting structures 110 can be made directly. Steps S1 to S5 can be repeated or several production lines can be adopted for carrying out Steps S1 to S5, depending on the required quantity of capillary supporting structures 110.

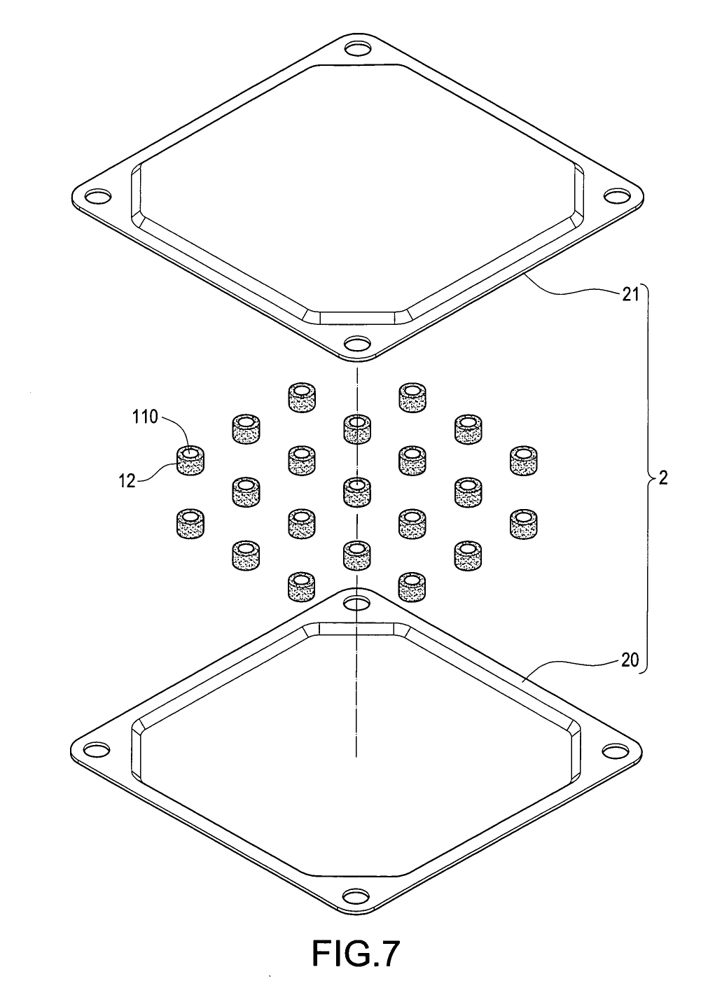

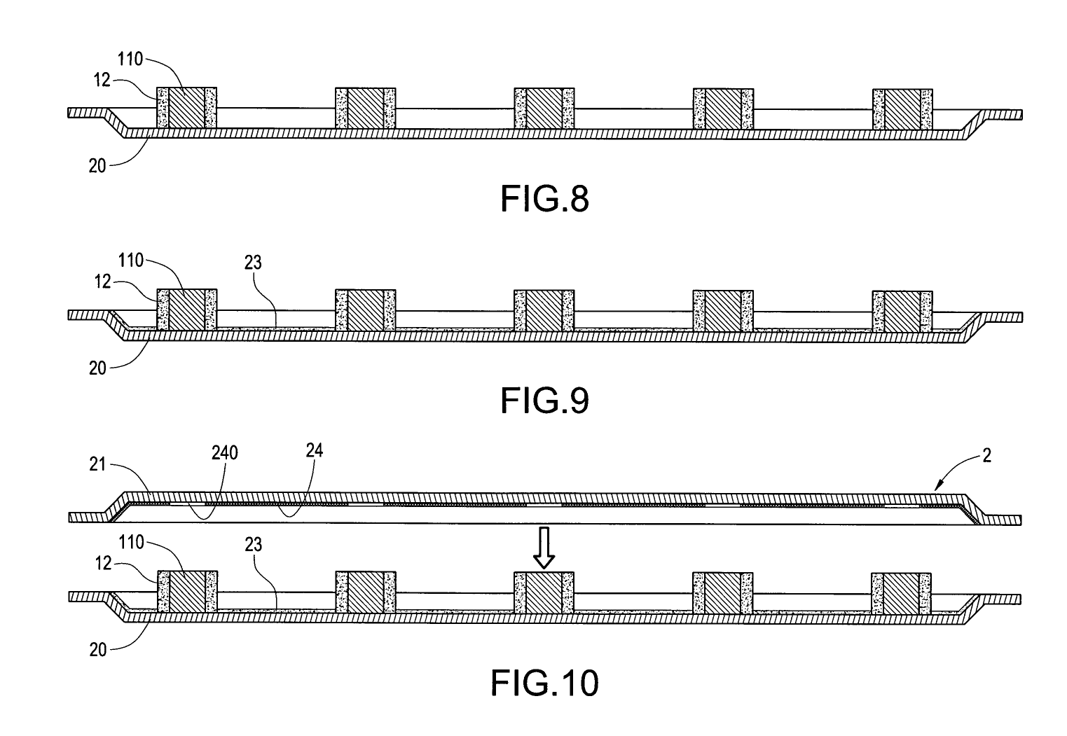

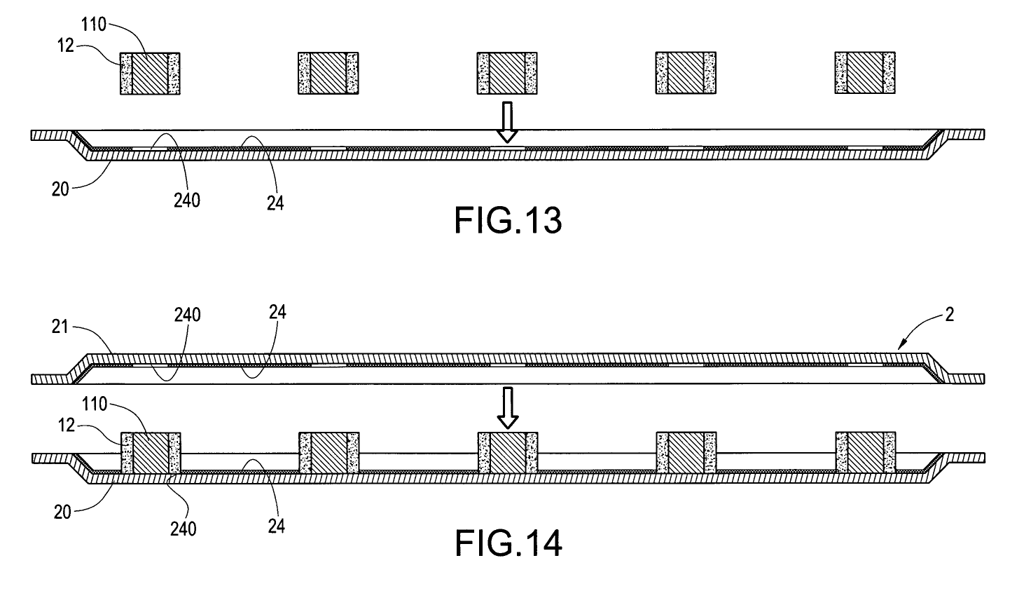

Referring to FIG. 7 together with Step S6 as shown in FIG. 1, two cover plates 20, 21 engaged with each other are used as the plate body 2 of the heat plate, and the two cover plates 20, 21 are prepared in a step before Step S1 or at the same time of Step S1. In Step S7 as shown in FIG. 1, the capillary supporting structures 110 are installed between the two cover plates 20, 21 (which are inside the plate body 2), and then the plate body 2 is sealed and engaged. The capillary tissues are attached onto the internal walls of the two cover plates 20, 21, but at least two different procedures are adopted depending on the following types of attached capillary tissues: a mixed type of meshed capillary tissues and sintered capillary tissues as shown in FIGS. 8 to 11, and a single type of meshed capillary tissues as shown in FIGS. 13 to 15.

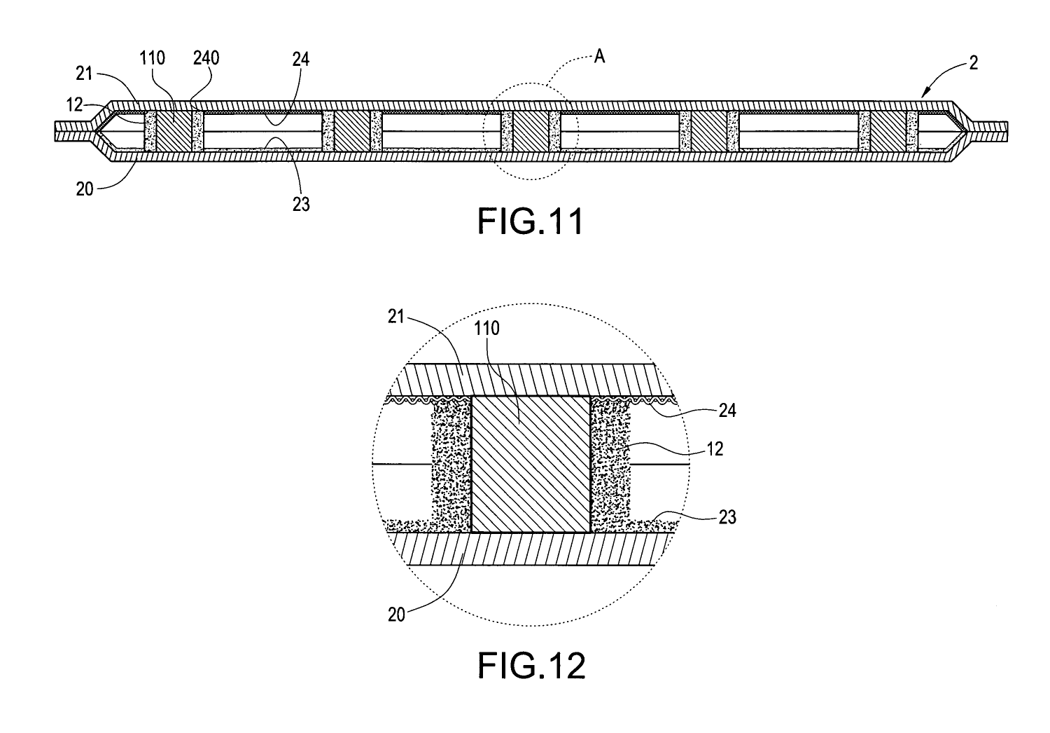

In summation of the description above, the mixed type of meshed and sintered capillary tissues as shown in FIG. 8 erects and distributes the capillary supporting structures 110 on an internal wall of any one of the cover plates 20, and then coats the sintered powder onto the cover plate 20 as shown in FIG. 9 to form the sintered capillary tissue 23, and attaches the meshed capillary tissue 24 onto an internal wall of another a cover plate 21 as shown in FIG. 10. The meshed capillary tissue 24 includes a bare hole 240 corresponding to the distribution of the capillary supporting structures 110, and the two cover plates 20, 21 are stacked and sealed with each other. In FIGS. 11 and 12, the heat plate as shown in FIGS. 8 to 10 includes the sintered capillary tissue 23 disposed on the internal wall of one of the cover plates 20, and thus is connected to the sintered powder 12 around the circumferential surface of each capillary supporting structure 110 for flowing the filled working fluid back successfully. The meshed capillary tissue 24 is disposed on the internal wall of the cover plate 21, and a bare hole 240 is reserved on the meshed capillary tissue 24 and corresponding to each capillary supporting structure 110, and the diameter of the bare hole 240 is substantially equal to the external diameter of a solid section of the capillary supporting structure 110, so that a distal surface of the sintered powder 12 attached onto the circumferential surface of the capillary supporting structure 110 is in contact with the meshed capillary tissue 24 (as shown in FIG. 12), and the woven metal filaments of the meshed capillary tissue 24 pierce into a distal surface of the sintered powder 12, and the meshed capillary tissue 24 and the sintered powder 12 of each capillary supporting structure 110 form a continuous capillary channel for flowing the working fluid back successfully.

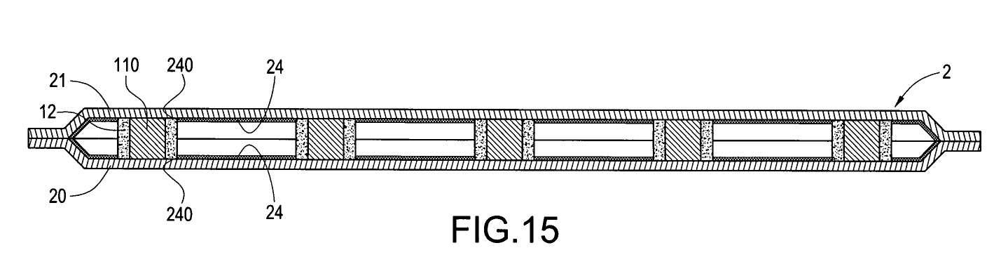

In a single type meshed capillary tissue as shown in FIG. 13, the meshed capillary tissue 24 is attached onto the internal walls of the two cover plates 20, 21, and the meshed capillary tissue 24 has a bare hole 240 corresponding to the distribution of the capillary supporting structures 110, and each capillary supporting structure 110 is installed at a position corresponding to the bare hole 240. After the two cover plates 20, 21 are stacked and engaged as shown in FIG. 14, the heat plate as shown in FIG. 15 is produced. The operations such as filling in the working fluid, removing air or vacuuming the heat plates after the heat plate is sealed will not be described here.

The foregoing procedure and structure constitute a heat plate with a capillary supporting structure and its manufacturing method in accordance with the present invention.

While the invention is described in by way of examples and in terms of preferred embodiments, it is to be understood that the invention is not limited thereto. On the contrary, the aim is to cover all modifications, alternatives and equivalents falling within the spirit and scope of the invention as defined by the appended claims.

What is claimed is:

1. A heat plate comprising:
a hollow plate, having a capillary tissue attached onto an internal wall thereof, and
a plurality of capillary supporting structures, erected, supported and distributed in the heat plate, and each of the capillary supporting structures being substantially in a cylindrical shape and having a capillary object made of a sintered powder and disposed on an circumferential surface of the cylindrical capillary supporting structure and contacted with the capillary tissue for forming a continuous capillary channel.

2. The heat plate with a capillary supporting structure as recited in claim 1, wherein the plate body is comprised of two cover plates engaged with each other, and the capillary tissue is attached onto two internal walls of the two cover plates.

3. The heat plate with a capillary supporting structure as recited in claim 2, wherein the capillary tissue includes a meshed capillary tissue attached on one internal wall of the two cover plates.

4. The heat plate with a capillary supporting structure as recited in claim 3, wherein the meshed capillary tissue includes a bare hole corresponding to the capillary supporting structure, and each bare hole has a hole diameter substantially equal to an external diameter of a solid section of the capillary supporting structure, and is contacted with a distal surface of the capillary object of each capillary supporting structure.

5. The heat plate with a capillary supporting structure as recited in claim 3, wherein the capillary tissue includes a sintered capillary tissue attached on the other internal wall of the two cover plates.

6. The heat plate with a capillary supporting structure as recited in claim 3, wherein the capillary tissue includes another meshed capillary tissue attached on the other internal wall of the two cover plates.

7. The heat plate with a capillary supporting structure as recited in claim 6, wherein the meshed capillary tissue includes a bare hole corresponding to each capillary supporting structure, and each bare hole has a hole diameter substantially equal to an external diameter of a solid section of the capillary supporting structure, and is contacted with a distal surface of the capillary object of each capillary supporting structure.

8. A method of manufacturing a heat plate with a capillary supporting structure, comprising the steps of:
(a) providing a sintering tool and a supporting object, and the sintering tool including an indented portion disposed therein for receiving the supporting object;
(b) placing the supporting object in an indented portion of the sintering tool;
(c) filling a sintered powder in the sintering tool and between the supporting object;
(d) heating the sintered powder of Step (c) to a temperature, for sintering the sintered powder to a surface of the supporting object;
(e) releasing an mold of the supporting object with the sintered powder, and the sintering tool to obtain the capillary supporting structure;
(f) providing two cover plates engaged with each other as a plate body of a heat plate; and
(g) placing the capillary supporting structure of Step (e) into the plate body and sealing the plate body.

9. The method of manufacturing a heat plate with a capillary supporting structure as recited in claim 8, wherein the supporting object of the Step (a) is substantially in shape of a rectangular bar, and the capillary supporting structure obtained from the Step (e) is divided after the Step (e).

10. The method of manufacturing a heat plate with a capillary supporting structure as recited in claim 8, wherein the Step (f) is executed before the Step (a).

11. The method of manufacturing a heat plate with a capillary supporting structure as recited in claim 8, wherein the Step (f) is executed together with the Step (a) at the same time.

12. The method of manufacturing a heat plate with a capillary supporting structure as recited in claim 8, wherein the Steps (a) to (e) are executed repeatedly to obtain the required quantity of the capillary supporting structure before the Step (g) is executed.

13. The method of manufacturing a heat plate with a capillary supporting structure as recited in claim 8, wherein a plurality of sets of the Steps (a) to (e) are executed simultaneously to obtain the required quantity of the capillary supporting structure before the Step (g) is executed.

14. The method of manufacturing a heat plate with a capillary supporting structure as recited in claim 8, wherein the Step (g) further comprising the steps of:
(g-1) placing the capillary supporting structure on an internal wall of one of the cover plates;
(g-2) putting and sintering the sintered powder onto the internal wall of the cover plate as in the Step (g-1);
(g-3) attaching a meshed capillary tissue onto an internal wall of the other cover plate, wherein the meshed capillary tissue has a bare hole corresponding to a distributed position of the capillary supporting structure; and
(g-4) sealing the two cover plates after stacking the two cover plates correspondingly.

15. The method of manufacturing a heat plate with a capillary supporting structure as recited in claim 8, wherein the Step (g) further comprising the steps of:
(g-1) attaching a meshed capillary tissue onto two internal walls of the two cover plates, wherein the meshed capillary tissue has a bare hole corresponding to a distributed position of the capillary supporting structure;
(g-2) installing the capillary supporting structures at positions corresponding to the bare holes; and
(g-3) sealing the two cover plates, after stacking the two cover plates correspondingly.
